(19) United States
(12) Patent Application Publication
(10) Pub. No.: US 2023/0322173 A1
(43) Pub. Date: Oct. 12, 2023

(54) METHOD FOR AUTOMATICALLY CONTROLLING VEHICLE INTERIOR DEVICES INCLUDING DRIVER`S SEAT AND APPARATUS THEREFOR

(71) Applicant: MOBILINT INC., Seoul (KR)

(72) Inventor: Jongjun PARK, Seoul (KR)

(73) Assignee: MOBILINT INC., Seoul (KR)

(21) Appl. No.: 18/334,242

(22) Filed: Jun. 13, 2023

Related U.S. Application Data
(63) Continuation of application No. PCT/KR2020/018450, filed on Dec. 16, 2020.

(51) Int. Cl. B60R 16/037; B60R 21/015; B60R 22/48; G06V 40/10

(52) U.S. Cl. CPC B60R 16/037; B60R 21/01538; B60R 22/48; G06V 40/10; B60R 2022/4808

(57) ABSTRACT

The present specification relates to a method for controlling vehicle interior devices. More specifically, the method comprises the steps of: acquiring image data of a vehicle passenger located within a predetermined distance from a vehicle through an object detection device provided in the exterior of the vehicle; extracting body structure information about the body structure of the vehicle passenger from the image data by using a skeletonization-related deep learning algorithm; and when opening of a specific door of the vehicle is detected, controlling passenger seat-related interior devices corresponding to the specific door on the basis of the extracted body structure information.

### CROSS-REFERENCE TO RELATED APPLICATIONS

The present application is a continuation of International Patent Application No. PCT/KR2020/018450, filed on Dec. 16, 2020. The disclosures of the above-listed application are hereby incorporated by reference herein in their entirety.

### BACKGROUND

Embodiments of the inventive concept described herein relate to a method for controlling an interior device of a vehicle, and more particularly, relate to a method for automatically adjusting an interior device of a vehicle including a driver seat of a vehicle passenger and a device supporting the same.

Nowadays, the number of users employing shared vehicle services such as Socar or high-end taxi services such as Kakao Black is increasing, and the frequency of regular use of the corresponding service is also increasing. Accordingly, when a user employs the corresponding service, automatic adjustment of a seat to be boarded by the user or a vehicle interior device related to the seat may be required before the corresponding user gets into a vehicle. To perform this automatic adjustment, a technology capable of automatically adjusting an interior device in the seat or vehicle needs to be developed in consideration of the fact that all body structures of users are different from one another. Otherwise, whenever a user employs the corresponding service, the user has the inconvenience of adjusting a location of the vehicle's interior devices, such as the vehicle's seat, rear view minor, side minor, and display device outputting content, depending on his/her body structure.

### SUMMARY

Embodiments of the inventive concept provide a method for automatically adjusting an interior device in a vehicle, such as a vehicle passenger's seat, or the like by obtaining image data of a vehicle passenger through an object detection device installed outside the vehicle and identifying a body structure of the vehicle passenger to minimize the above-mentioned user inconvenience.

The technical problems to be solved by embodiments of the inventive concept are not limited to the aforementioned problems, and other technical problems that are not mentioned will be clearly understood by those skilled in the art from the following description.

According to an embodiment, a vehicle for adjusting an interior device includes an object detection device installed outside the vehicle and acquiring image data of a vehicle passenger located within a predetermined distance from the vehicle, the image data including distance information indicating a distance between the vehicle and the vehicle passenger, an artificial intelligence (AI) device that extracts body structure information about a body structure of the vehicle passenger from the image data by using a skeletonization-related deep learning algorithm, the body structure information including at least one of body portion location information about a location of each of body portions related to adjustment of the interior device in the body structure of the vehicle passenger, body portion size information for a size of each of the body portions, or specific detail information of a body portion with specific details in the body structure of the vehicle passenger, a sensing device that detects whether a specific door of the vehicle is opened or closed, and a control device that adjusts an interior device related to a boarding seat corresponding to the specific door based on the extracted body structure information.

Moreover, in this specification, when it is detected by the sensing device that the specific door is opened, the control device allows the interior device to be adjusted based on the extracted body structure information.

Moreover, in this specification, the size of each of the body portions is calculated based on the distance information included in the image data.

Moreover, in this specification, the specific detail information corresponds to whether the vehicle passenger is pregnant or whether the vehicle passenger is disabled.

Moreover, in this specification, each of the body portions related to the adjustment of the interior device is an eye, an elbow, a knee, a waist, an arm, a leg, an upper body, or a neck.

Moreover, in this specification, the vehicle further includes an output unit. The control device allows the output unit to output a notification signal indicating that acquisition of the image data is ended, in a visual, auditory, olfactory or tactile form.

Moreover, in this specification, the object detection device consists of one stereo camera, two cameras, or one ultrasonic sensor and one camera.

Moreover, in this specification, the interior device includes at least one of a seat of the boarding seat corresponding to the specific door, a steering wheel, a rear-view minor, a side minor, a display device disposed in a rear seat of the vehicle, a massage device, an airbag, or a safety belt.

Moreover, in this specification, when the vehicle passenger is an infant or child, the control device adjusts the airbag or the safety belt.

According to an embodiment, a method for adjusting an interior device of a vehicle includes acquiring image data of a vehicle passenger located within a predetermined distance from the vehicle through an object detection device installed outside the vehicle, the image data including distance information indicating a distance between the vehicle and the vehicle passenger, extracting body structure information about a body structure of the vehicle passenger from the image data by using a skeletonization-related deep learning algorithm, the body structure information including at least one of body portion location information about a location of each of body portions related to adjustment of the interior device in the body structure of the vehicle passenger, body portion size information for a size of each of the body portions, or specific detail information of a body portion with specific details in the body structure of the vehicle passenger, and when it is detected that a specific door of the vehicle is opened, adjusting an interior device related to a boarding seat corresponding to the specific door based on the extracted body structure information.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a control block diagram of a vehicle, according to an embodiment of the inventive concept;

FIG. 2 is a block diagram of an AI device, according to an embodiment of the inventive concept;

FIG. 3 is an example of a DNN model to which the inventive concept is capable of being applied;

FIG. 4 is a flowchart illustrating an example of a method for adjusting an interior device of a vehicle proposed in this specification;

FIG. 5 shows an example of skeletonizing a human body structure through a skeletonization-related deep learning algorithm; and

FIG. 6 is a flowchart illustrating an example of a method for adjusting an interior device of a vehicle proposed in this specification.

### DETAILED DESCRIPTION

It should be noted that technical terms used in this specification are only used to describe specific embodiments and are not intended to limit the spirit of the technology disclosed in this specification. Moreover, unless specifically defined otherwise in this specification, technical terms used in this specification should be interpreted in terms commonly understood by those of ordinary skill in the field to which the technology disclosed in this specification belongs, and should not be interpreted in an excessively comprehensive meaning or an excessively reduced meaning. Furthermore, when the technical terms used in this specification are incorrect technical terms that do not accurately express the spirit of the technology disclosed in this specification, it should be understood as being replaced with technical terms capable of being correctly understood by those skilled in the art in the field to which the technology disclosed in this specification belongs. Besides, general terms used in this specification should be interpreted as defined in advance or according to context, and should not be interpreted in an excessively reduced meaning.

Terms including ordinal numbers such as first and second used in this specification may be used to describe various components, but the components should not be limited by the terms. The terms are only used to distinguish one component from another component. For example, without departing the scope of the inventive concept, a first component may be referred to as a second component, and similarly, a second component may be referred to as a first component.

Hereinafter, the embodiments disclosed in this specification will be described in detail with reference to the accompanying drawings, but the same or similar components are assigned the same reference numerals regardless of reference numerals, and redundant description thereof will be omitted.

Moreover, in describing the scope and spirit of the inventive concept, when it is determined that the specific description of the known related art unnecessarily obscures the gist of the inventive concept, the detailed description thereof will be omitted. Furthermore, it should be noted that the accompanying drawings are only intended to facilitate understanding of the spirit of the technology disclosed in this specification, and should not be construed as limiting the spirit of the technology by the accompanying drawings.

### Components of Vehicle

A vehicle used in this specification is defined as a means of transport running on a road or a track. The vehicle is a concept that includes a car, a train, and a motorcycle. The vehicle may have a concept including all of an internal combustion engine vehicle including an engine as a power source, a hybrid vehicle including an engine and an electric motor as a power source, an electric vehicle including an electric motor as a power source, and the like. The vehicle may be a vehicle owned by an individual. The vehicle may be a shared vehicle.

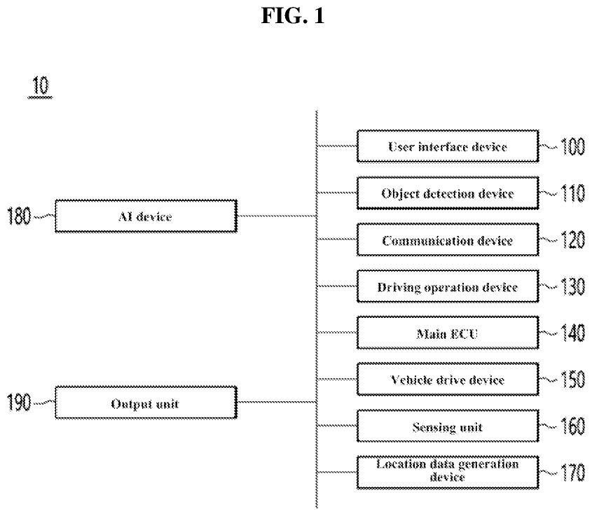

FIG. 1 is a control block diagram of a vehicle, according to an embodiment of the inventive concept.

Referring to FIG. 1, a vehicle 10 may include a user interface device 100, an object detection device 110, a communication device 120, a driving operation device 130, a main ECU 140, a vehicle drive device 150, a sensing unit 160, a location data generation device 170, an artificial intelligence (AI) device 180, and an output unit 190. The object detection device 110, the communication device 120, the driving operation device 130, the main ECU 140, the vehicle drive device 150, the sensing unit 160 and the location data generation device 170 may be implemented as electronic devices that generate electrical signals and exchange the electrical signals with one another, respectively.

The user interface device 100 is a device for communication between a vehicle and a user. The user interface device may receive a user input and may provide information generated by the vehicle to the user. The vehicle may implement a user interface (UI) or user experience (UX) through a user interface device. The user interface device may include an input device, an output device, and a user monitoring device.

The object detection device 110 may generate information about an object outside the vehicle. The information about an object may include at least one of information about whether an object is present, location information of the object, information about a distance between a vehicle and the object, and information about the relative speed between the vehicle and the object. The object detection device may detect an object outside the vehicle. The object detection device may include at least one sensor capable of detecting an object outside the vehicle. The object detection device may include at least one of a camera, radar, LiDAR, an ultrasonic sensor, and an infrared sensor. The object detection device may provide data on an object, which is generated based on a sensing signal generated by a sensor, to at least one electronic device included in the vehicle.

The camera may generate information about an object outside the vehicle by using an image. The camera may further include at least one processor that processes a signal received while being electrically connected to at least one lens, at least one image sensor, and an image sensor and generates data on the object based on the processed signal.

The camera may be at least one of a mono camera, a stereo camera, or an around view monitoring (AVM) camera. The camera may obtain location information of an object, information about a distance to the object, or information about a relative speed of an object, by using various image processing algorithms. For example, the camera may obtain distance information and relative speed information of an object from the obtained image based on a change in object size over time. For example, the camera may obtain distance information and relative speed information of an object through a pinhole model, road profiling, and the like. For example, the camera may obtain distance information and relative speed information of an object based on disparity information from a stereo image obtained from a stereo camera.

The camera may be mounted in a location capable of securing a field of view (FOV) in the vehicle to capture the outside of the vehicle. To obtain an image in front of a vehicle, the camera may be positioned in the interior of the vehicle to be close to a front windshield. The camera may be positioned around the front bumper or radiator grille. To obtain an image behind the vehicle, the camera may be positioned in the interior of the vehicle to be close to a rear glass. The camera may be positioned around a rear bumper, trunk or tailgate. To obtain a side image of the vehicle, the camera may be positioned to be close to at least one of side windows inside a vehicle. Alternatively, the camera may be positioned around a side minor, a fender, or a door.

The radar may generate information about an object outside the vehicle by using radio waves. The radar may further include at least one processor that processes a signal received while being electrically connected to an electromagnetic wave transmitter, an electromagnetic wave receiver, and the electromagnetic wave transmitter and the electromagnetic wave receiver and generates data on the object based on the processed signal. The radar may be implemented in a pulse radar method or a continuous wave radar method in view of the radio emission principle. The radar may be implemented in a frequency modulated continuous wave (FMCW) method or a frequency shift keying (FSK) method depending on a signal waveform among continuous wave radar methods. On the basis of the TOF method or phase-shift method, the radar may detect an object and may detect a location of the detected object, a distance to the detected object, and a relative speed by using electromagnetic waves. The radar may be positioned at an appropriate location outside the vehicle to detect an object located at the front of the vehicle, the rear of the vehicle, or the side of the vehicle.

The LiDAR may generate information about an object outside the vehicle by using laser light. The LiDAR may further include at least one processor that processes a signal received while being electrically connected to a light transmitter, a light receiver, and the light transmitter and the light receiver and generates data on the object based on the processed signal. The LIDAR may be implemented in a time-of-flight (TOF) method or a phase-shift method. The LiDAR may be implemented as being in a driven method or non-driven method. When the LiDAR is implemented in the driven method, the LiDAR may detect an object around the vehicle while being rotated by a motor. When the LiDAR is implemented in the non-driven method, the LiDAR may detect an object located within a predetermined range based on the vehicle by optical steering. The vehicle may include a plurality of non-driven LiDARs. On the basis of the TOF method or phase-shift method, the LiDAR may detect an object and may detect a location of the detected object, a distance to the detected object, and a relative speed by using laser light. The LiDAR may be positioned at an appropriate location outside the vehicle to detect an object located at the front of the vehicle, the rear of the vehicle, or the side of the vehicle.

The communication device 120 may exchange signals with a device located outside the vehicle. The communication device may exchange signals with at least one of an infrastructure (e.g., a server and a broadcasting station), another vehicle, and a terminal. To perform communication, the communication device may include at least one of a transmission antenna, a reception antenna, a radio frequency (RF) circuit capable of implementing various communication protocols, and an RF element.

For example, the communication device may exchange signals with an external device based on a cellular V2X (C-V2X) technology. For example, the C-V2X technology may include LTE-based sidelink communication and/or NR-based sidelink communication.

For example, the communication device may exchange signals with external devices based on dedicated-short-range-communications (DSRC) technology based on IEEE 802.11p PHY/MAC layer technology and IEEE 1609 network/transport layer technology, or Wireless Access in Vehicular Environment (WAVE) standard. The DSRC (or WAVE standard) technology refers to a communication standard prepared to provide Intelligent Transport System (ITS) service through dedicated short-distance communication between vehicle-mounted devices or between a roadside device and a vehicle-mounted device. The DSRC technology may use a frequency of 5.9 GHz band and may be a communication method having a data transmission rate of 3 Mbps to 27 Mbps. The IEEE 802.11p technology may be combined with IEEE 1609 technology to support the DSRC technology (or WAVE standard).

The communication device according to an embodiment of the inventive concept may exchange signals with an external device by using only one of C-V2X technology or DSRC technology. Alternatively, the communication device according to an embodiment of the inventive concept may exchange signals with an external device by hybridizing the C-V2X technology and DSRC technology.

The driving operation device 130 is a device that receives a user input for driving. In the case of a manual mode, the vehicle may operate based on a signal provided by the driving operation device 130. The driving operation device 130 may include a steering input device (e.g., a steering wheel), an acceleration input device (e.g., an accelerator pedal), and a brake input device (e.g., a brake pedal).

The main ECU 140 may control the overall operation of at least one electronic device provided in the vehicle. The main ECU may be expressed as a control unit, a processor, or the like.

The control unit may be referred to as an “application processor (AP)”, “processor”, “control module”, “controller”, “micro-controller”, “microprocessor”, or the like. The processor may be implemented by hardware, firmware, software, or a combination thereof. The control unit may include an application-specific integrated circuit (ASIC), other chipsets, logic circuits, and/or data processing devices.

The main ECU allows an interior device related to a passenger seat corresponding to a specific door of the vehicle to be adjusted based on body structure information extracted from image data obtained by the object detection device by applying a skeletonization-related deep learning algorithm.

Moreover, when the opening of a specific door is detected by the sensing unit to be described later, the main ECU allows the interior device to be adjusted based on the extracted body structure information.

Furthermore, when the vehicle passenger is an infant or child, the main ECU allows an airbag or a seatbelt to be adjusted.

The vehicle drive device 150 is a device that electrically controls various vehicle drive devices in the vehicle. The vehicle drive device 150 may include a power train drive control device, a chassis drive control device, a door/window drive control device, a safety device drive control device, a lamp drive control device, and an air conditioning drive control device. The power train driving control device may include a power source driving control device and a transmission driving control device. The chassis drive control device may include a steering drive control device, a brake drive control device, and a suspension drive control device. In the meantime, the safety device drive control device may include a safety belt drive control device for controlling safety belts.

The vehicle drive device 150 includes at least one electronic control device (e.g., a control electronic control unit (ECU)).

The sensing unit 160 or sensing device may sense a state of the vehicle. The sensing unit 160 may include at least one of an inertial measurement unit (IMU) sensor, a collision sensor, a wheel sensor, a speed sensor, an inclination sensor, a weight detection sensor, a heading sensor, a position module, and a vehicle forward/backward sensor, a battery sensor, a fuel sensor, a tire sensor, a steering sensor, a temperature sensor, a humidity sensor, an ultrasonic sensor, an illuminance sensor, and a pedal position sensor. In the meantime, the IMU sensor may include one or more of an acceleration sensor, a gyro sensor, and a magnetic sensor.

The sensing unit 160 may generate state data of the vehicle based on a signal generated by at least one sensor. The vehicle state data may be information generated based on data sensed by various sensors provided inside the vehicle. The sensing unit 160 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle inclination data, vehicle forward/backward data, vehicle weight data, battery data, fuel data, tire air pressure data, vehicle internal temperature data, vehicle internal humidity data, steering wheel rotation angle data, vehicle external illuminance data, data on pressure applied to an accelerator pedal, data on pressure applied to a brake pedal, vibration data, and the like.

In addition, the sensing unit may detect whether a specific door of the vehicle is opened or closed.

The location data generation device 170 may generate location data of the vehicle. The location data generation device may include at least one of Global Positioning System (GPS) and Differential Global Positioning System (DGPS). The location data generation device may generate the location data of the vehicle based on a signal generated by at least one of GPS and DGPS. According to the embodiment, the location data generation device 170 may correct location data based on at least one of an IMU of the sensing unit 160 and a camera of the object detection device 110. The location data generation device may be named Global Navigation Satellite System (GNSS).

The vehicle may include an internal communication system. A plurality of electronic devices included in the vehicle may exchange signals via an internal communication system. The signals may include data. The internal communication system may use at least one communication protocol (e.g., CAN, LIN, FlexRay, MOST, or Ethernet).

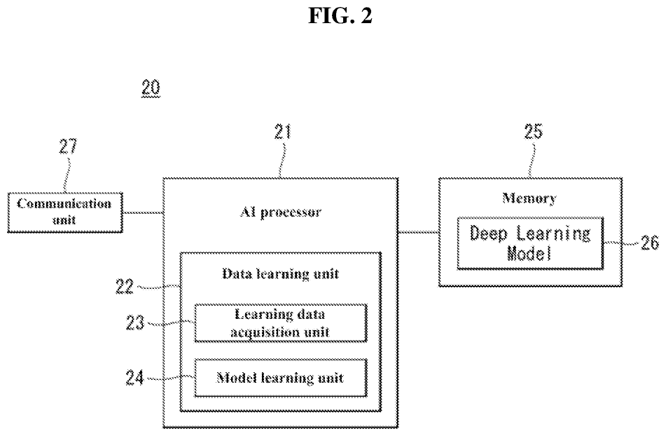

Besides, a vehicle, other than the block diagram shown in FIG. 1, may additionally include a block diagram of an AI device in FIG. 2 to perform a method proposed in this specification. That is, the vehicle proposed in this specification may include an AI device including an AI processor, a memory, or the like which will be described later, or individual components.

### Block Diagram of AI Device

FIG. 2 is a block diagram of an AI device, according to an embodiment of the inventive concept.

An AI device 20 may include an electronic device including an AI module capable of performing AI processing, a server including the AI module, or the like. Moreover, the AI device may be included in at least one partial configuration of an electronic device to perform at least part of AI processing together.

The AI device may include an AI processor 21, a memory 25, and/or a communication unit 27.

The AI device may be a computing device capable of learning a neural network, and may be implemented in various electronic devices such as a server, a desktop PC, a notebook PC, and a tablet PC.

The AI processor may learn the neural network by using a program stored in a memory. In particular, the AI processor may learn a neural network for recognizing vehicle-related data. Here, the neural network for recognizing the vehicle-related data may be designed to simulate a human brain structure on a computer, and may include a plurality of network nodes, each of which has a weight and which simulate neurons of a human neural network. The plurality of network modes may exchange data depending on each connection relationship such that neurons simulate synaptic activity of neurons that exchange signals through synapses. Here, the neural network may include a deep learning model developed from a neural network model. In the deep learning model, a plurality of network nodes may exchange data depending on a convolution connection relationship while being located on different layers. Examples of neural network models may include various deep learning techniques such as deep neural networks (DNN), convolutional deep neural networks (CNN), recurrent neural networks (RNN) restricted Boltzmann machine (RBM), deep belief networks (DBN), and deep Q-networks, and may be applied to fields such as computer vision, speech recognition, natural language processing, and speech/signal processing.

In the meantime, a processor performing functions described above may be a general-purpose processor (e.g., CPU), or may be an AI-dedicated processor (e.g., GPU) for artificial intelligence learning.

The memory may store various programs and data, which are necessary for an operation of the AI device. The memory may be implemented as a non-volatile memory, a volatile memory, a flash-memory, a hard disk drive (HDD), or a solid state drive (SSD). The memory may be accessed by the AI processor, and data may be read/written/modified/deleted/updated by the AI processor. Furthermore, the memory may store a neural network model (e.g., a deep learning model 26) generated through a learning algorithm for data classification/recognition according to an embodiment of the inventive concept.

In the meantime, the AI processor 21 may include a data learning unit 22 that learns a neural network for data classification/recognition. The data learning unit 22 may learn a criterion for learning data use to determine data classification/recognition, and a method of classifying and recognizing data by using the learning data. The data learning unit 22 may learn a deep learning model by obtaining learning data to be used for learning and applying the obtained learning data to a deep learning model.

The data learning unit 22 may be manufactured in a form of at least one hardware chip to be mounted on the AI device 20. For example, the data learning unit 22 may be manufactured in a type of a dedicated hardware chip for AI, and may be manufactured as a part of a general-purpose processor (CPU) or a graphic-dedicated processor (GPU) to be mounted on the AI device 20. Furthermore, the data learning unit 22 may be implemented as a software module. When the data learning unit 22 is implemented as a software module (or a program module including instructions), the software module may be stored in non-transitory computer readable media capable of being read by a computer. In this case, at least one software module may be provided by an operating system (OS) or an application.

The data learning unit 22 may include a learning data acquisition unit 23 and a model learning unit 24.

The learning data acquisition unit 23 may obtain learning data necessary for a neural network model for classifying and recognizing data. For example, the learning data acquisition unit 23 may obtain vehicle data and/or sample data, which is to be input to a neural network model, as learning data.

The model learning unit 24 may learn the neural network model such that the neural network model has a determination criterion for classifying predetermined data, by using the obtained learning data. In this case, the model learning unit 24 may learn the neural network model through supervised learning that uses at least some of the learning data as the determination criterion. Alternatively, the model learning unit 24 may learn the neural network model through unsupervised learning that discovers the determination criterion by learning by itself by using the learning data without supervision. Moreover, the model learning unit 24 may learn the neural network model through reinforcement learning by using feedback about whether the result of the situation determination according to learning is correct. Furthermore, the model learning unit 24 may learn a neural network model by using a learning algorithm including error back-propagation or gradient decent.

When the neural network model is learned, the model learning unit 24 may store the learned neural network model in a memory. The model learning unit 24 may store the learned neural network model in the memory of a server connected to the AI device 20 through a wired or wireless network.

The data learning unit 22 may further include a learning data pre-processing unit (not shown) and a learning data selection unit (not shown) to improve the analysis result of the recognition model or to save resources or time required for generating the recognition model.

The learning data pre-processing unit may pre-process the obtained data such that the obtained data is capable of being used for learning for situation determination. For example, the learning data pre-processing unit may process the obtained data in a predetermined format such that the model learning unit 24 is capable of using the obtained learning data for learning for image recognition.

Moreover, the learning data selection unit may select data necessary for learning from among learning data obtained by the learning data acquisition unit 23 or learning data pre-processed by the pre-processing unit. The selected learning data may be provided to the model learning unit 24. For example, the learning data selection unit may select, as learning data, only data for an object included in a specific region by detecting a specific region in the image obtained through a camera of a vehicle.

In addition, the data learning unit 22 may further include a model evaluation unit (not shown) to improve the analysis result of a neural network model.

The model evaluation unit may input evaluation data to the neural network model. When the analysis result output from the evaluation data does not satisfy a predetermined criterion, the model evaluation unit may allow the model learning unit 24 to learn again. In this case, the evaluation data may be predefined data for evaluating the recognition model. For example, when the number or ratio of the evaluation data having inaccurate analysis results exceeds a predetermined threshold from among the analysis results of the learned recognition model for the evaluation data, the model evaluation unit may evaluate that the evaluation data does not satisfy a predetermined criterion.

The communication unit 27 may transmit an AI processing result by the AI processor 21 to an external electronic device.

Here, the external electronic device may be defined as an autonomous vehicle. Furthermore, the AI device 20 may be defined as another vehicle or a 5G network that communicates with the autonomous driving module vehicle. In the meantime, the AI device 20 may be implemented by being functionally embedded in an autonomous driving module provided in a vehicle. In addition, the 5G network may include a server or module that performs control related to autonomous driving. Moreover, the AI device 20 may be implemented through a home server.

Meanwhile, it is described that the AI device 20 shown in FIG. 2 is functionally divided into the AI processor 21, the memory 25, the communication unit 27, or the like. However, it should be noted that the above-described components may be integrated into one module and then may be referred to as an “AI module”.

### Deep Neural Network (DNN) Model

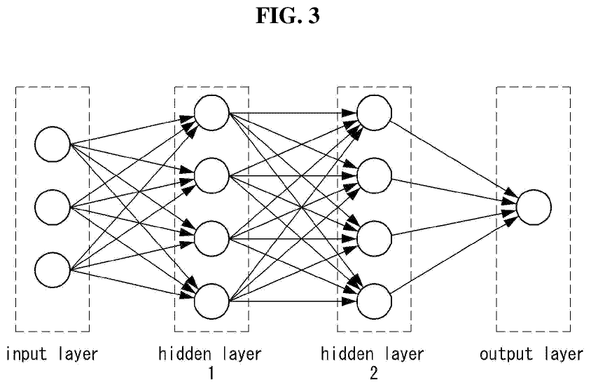

FIG. 3 is an example of a DNN model to which the inventive concept is capable of being applied.

The DNN is an artificial neural network (ANN) consisting of several hidden layers between an input layer and an output layer. Like general ANNs, the DNN may model complex non-linear relationships.

For example, in a DNN structure for an object identification model, each object may be expressed as a hierarchical configuration of image basic elements. At this time, additional layers may consolidate characteristics of lower layers that are gradually gathered. This feature of DNN makes it possible to model complex data with only fewer units (or nodes) compared to similarly performed ANNs.

As the number of hidden layers increases, the ANN is called ‘deep’. In this way, a machine learning paradigm that uses a sufficiently deep ANN as a learning model is called “deep learning”. In addition, sufficiently deep ANNs used for such deep learning are collectively referred to as “DNN”.

In the inventive concept, pieces of data required for learning a POI data generation model may be input to the input layer of the DNN. While the pieces of data go through hidden layers, meaningful data capable of being used by users may be created through output layers.

In the specification of the inventive concept, ANNs used for such the deep learning methods are collectively referred to as “DNNs”. However, it is obvious that other deep learning methods may be applied as long as the meaningful data is capable of being output in a similar way.

### Smart Adjustment Method for Vehicle Interior Device including Driver Seat

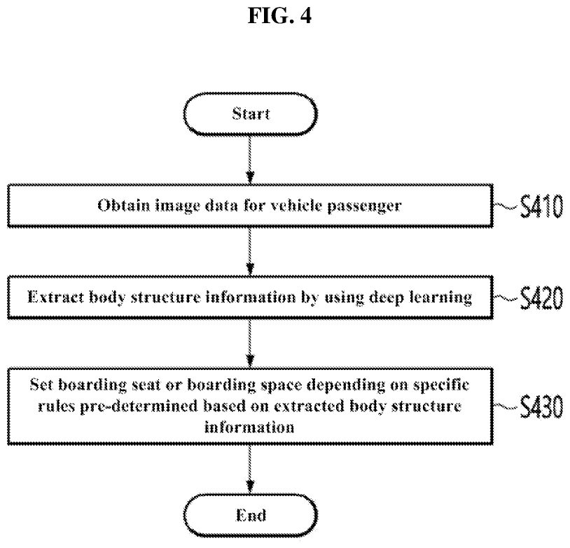

FIG. 4 is a flowchart illustrating an example of a method for adjusting an interior device of a vehicle proposed in this specification.

First of all, a vehicle obtains image data for a vehicle passenger within a specific radius from the vehicle by using an object detection device provided outside the vehicle (S410).

The object detection device may refer to one stereo camera or two cameras configured as one set. When the object detection device corresponds to two cameras, the two cameras may be side cameras attached to both sides of the vehicle.

Alternatively, the object detection device may consist of one ultrasonic sensor and one camera.

Here, the vehicle passenger may mean a person who rides in a driver's seat of a vehicle, an assistant's seat of a vehicle, or a rear seat of a vehicle.

The image data may include distance information between the vehicle and the vehicle passenger.

Next, the vehicle extracts body structure information related to a body structure of the vehicle passenger from the image data obtained based on the object detection device by using an AI algorithm such as skeletonization-related deep learning (S420).

Different AI algorithms for extracting body structure information of the vehicle passenger may be used for each vehicle.

When a user employs a shared vehicle service, the vehicle may collect past vehicle use history data for each user that employs the shared vehicle service through an AI algorithm used to extract body structure information. Accordingly, the vehicle allows the user to adjust the seat location and backrest of a seat to be occupied, based on history data of a user employing the corresponding vehicle, without obtaining the above-described image data again.

Moreover, when a user employs the advanced taxi service, the vehicle may automatically adjust the location of a rear seat, the backrest, and the angle of the display location provided in the rear seat at the immediately sensed location, through only detecting whether the seat to be boarded by the user is on the left or right side by using the result indicating that the vehicle passenger rides in the back seat of the vehicle.

The body structure information may include at least one of location information about a location of a main portion of a body related to a part, which is required to be adjusted when a vehicle passenger boards the vehicle, in the body structure of the vehicle passenger, size information about a size of the main portion, or information about specific details, which are unique, in the body structure.

For example, the information about specific details may be whether the vehicle passenger is pregnant, whether the vehicle passenger is disabled at a specific body portion, and the like.

For example, the main portion of the body may include eyes, elbows, knees, a height, a waist, and each joint.

Next, on the basis of specific rules pre-determined based on the extracted body structure information, the vehicle (1) sets a boarding seat (e.g., a driver seat, a passenger seat, or a rear seat) that the vehicle passenger will ride in so as to be optimized for the vehicle passenger, or (2) sets a boarding space for the vehicle passenger to be optimized for the vehicle passenger (S430).

Here, an example of setting the boarding seat to be optimized for the vehicle passenger may be adjusting a location of a steering wheel, adjusting a location of a seat, adjusting a location of side and rear-view mirrors, adjusting a backrest, or the like so as to be suitable for the vehicle passenger.

Furthermore, for example, setting the boarding area to be optimized for the vehicle passenger may be adjusting a location of a passenger seat, a location of a display device, and a massage chair so as to be suitable for the vehicle passenger.

Next, a method of obtaining image data by scanning a vehicle passenger through an object detection device will be described in detail.

Firstly, a vehicle obtains image data including distance information about a distance between the vehicle and a vehicle passenger, body size information about a body size of the vehicle passenger, and image information indicating the overall image of the vehicle passenger by using an object detection device (e.g., 1 stereo camera or 2 cameras facing the same direction) installed outside the vehicle.

In more detail, the object detection device may be (1) two cameras facing the same direction (or the same point) (e.g., cameras on both sides), (2) one stereo camera, or (3) a rear detection sensor and rear camera (an ultrasound, radar, LiDAR, etc.).

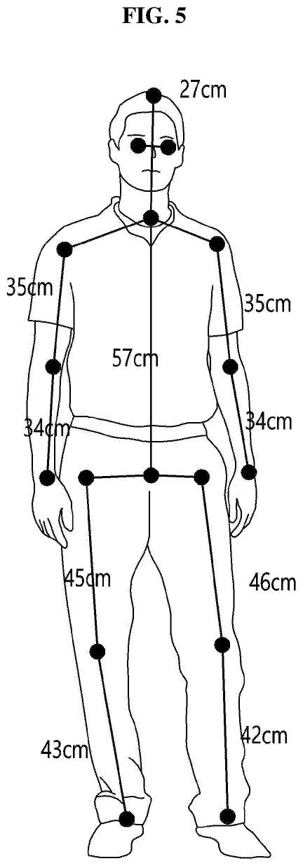

Afterward, the vehicle extracts body structure information, which is required for settings optimized depending on a vehicle passenger with respect to a seat, a wheel, a steering wheel, a rear-view minor, a side minor, a display device, various convenience control devices such as a massage chair at a back seat, various safety devices such as airbags and safety belts, and the like, by using a deep learning algorithm that skeletonizes an image of a person with the obtained image data as an input (See FIG. 5). FIG. 5 shows an example of skeletonizing a human body structure through a skeletonization-related deep learning algorithm, and shows information about each location and size of a body structure.

The body structure information may include information about a location of a body structure, (i.e., location information such as eyes, elbows, knees, a waist, arms, legs, an upper body, and a neck). Moreover, the vehicle may extract size information about a body size of a vehicle passenger by using the obtained distance information between a vehicle and a vehicle passenger. Furthermore, the vehicle may extract specific detail information (i.e., whether the vehicle passenger is pregnant) about specific details of the vehicle passenger's body structure and disability information such as whether the vehicle passenger has a disability.

Afterward, the vehicle may be configured to optimize a seat occupied by the vehicle passenger, a related interior space, or a convenience device installed in the interior space based on information related to the extracted body structure.

Next, a method of identifying a location (i.e., a seat, on which the vehicle passenger rides in, from among a driver seat, a passenger seat, or a rear seat) of a vehicle at which a vehicle passenger rides will be described in detail.

Steps to be described later may be performed after body structure information is obtained by the object detection device and then a signal indicating that the image scan of the vehicle passenger is over is output.

The signal indicating that the scan is over may be a visual signal, an auditory signal, a tactile signal, or an olfactory signal. An example of the auditory signal may be a sound such as ‘beep’, and an example of the visual signal may be ‘light’.

Besides, to identify a location of a seat occupied by the vehicle passenger, the vehicle may be equipped with a sensing unit, (particularly, a vibration sensor) at each door and may detect a sound such as a ‘knock’ generated at each door.

Through the following methods (Methods 1 to 3), the vehicle may determine a door through which the vehicle passenger boards.

### Method 1

In a case of Method 1, when a vehicle detects a knock of a vehicle passenger at a specific door, or when a specific door is opened, the vehicle may identify a boarding seat boarded by the vehicle passenger. Afterward, the vehicle obtains image data for the vehicle passenger through an object detection device and extracts body structure information about a body structure from the image data. After that, the vehicle adjusts a seat of the vehicle passenger to be boarded based on the body structure information.

That is, in Method 1, the vehicle knows which seat the vehicle passenger will board before the vehicle passenger boarding the vehicle. However, to obtain additional body structure information of the vehicle passenger, the vehicle passenger needs to wait outside the vehicle for a specific amount of time.

### Method 2

Unlike Method 1, in Method 2, the vehicle first obtains body structure information about the vehicle passenger's body structure by using the object detection device. Moreover, the vehicle detects or receives a signal indicating that the scan for the vehicle passenger has ended. Afterward, when the vehicle detects knocking on a door through a sensing unit in a specific door of the vehicle, or the vehicle detects that a specific door of the vehicle has been opened, the vehicle adjusts a seat corresponding to the detected door or automatically adjusts an indoor space or a convenience device provided in the indoor space, based on the body structure information.

In other words, unlike Method 1, in method 2, there is no inconvenience for the vehicle passenger to wait outside for a specific time before the vehicle passenger boards the vehicle.

### Method 3

In a case of Method 3, when the vehicle passenger uses a shared car service, the vehicle passenger may assign a boarding seat through a smartphone connected to the shared vehicle in advance to automatically adjust the specific seat or convenience device of the indoor space through the smartphone in consideration with that fact that the vehicle passenger opens/closes a door of the shared car by using the smartphone. In this case, the vehicle obtains the body structure information of the vehicle passenger. Afterward, the vehicle immediately adjusts the boarding seat assigned by the smartphone based on the obtained body structure information.

### Method 4

Method 4 relates to a method of adjusting a boarding seat of a vehicle passenger without using the sensing unit (i.e., a vibration sensor) like method 2 as a vehicle may determine which door the vehicle passenger is boarding at, when the object detection device such as a camera capable of scanning the vehicle passenger's body structure is provided for each door or capable of identifying the vehicle passenger's body structure for each door (i.e., when the object detection device is matched one by one for each seat as a single product).

Finally, information utilized by a vehicle in image data to automatically adjust a passenger seat after the vehicle scans an image of a vehicle passenger through an object detection device will be described in detail.

The vehicle obtains image data including at least one of an image of the vehicle passenger, distance information about a distance between the vehicle and the vehicle passenger, or specific information about specific details of the body structure by using the object detection device.

Furthermore, the vehicle extracts the body structure information of the vehicle passenger by using a deep learning algorithm that skeletonizes the obtained image data.

The body structure information may be location information of a main portion (i.e., eyes, elbows, knees, a waist, arms, legs, an upper body, and a neck).

Also, the vehicle extracts size information about a size of the body structure and specific detail information about specific details such as pregnancy or disability of the vehicle passenger by using distance information between the vehicle and vehicle passenger.

Next, a method of adjusting an indoor space including a rear seat of a vehicle or a convenience device in an indoor space when a vehicle passenger normally uses the rear seat of the vehicle in the case of an advanced vehicle service will be described in detail.

### Method 1

Method 1 refers to a method of obtaining body structure information about a body structure of a vehicle passenger and adjusting a location of the passenger seat or an angle of a location of a display device provided in front of a passenger seat to fit the vehicle passenger, as a method considering the comfort of vehicle passengers.

### Method 2

Method 2 refers to a method of obtaining body structure information about a body structure of a vehicle passenger and adjusting locations of safety belts and locations of airbags in a boarding seat to suit the vehicle passenger, as a method considering the safety of vehicle passengers. In particular, when the vehicle passenger is an infant or child, the starting point of the safety belt for the vehicle passenger may be positioned at a low location compared with a normal case (i.e., a case that the vehicle passenger is an adult) under control of the vehicle.

Furthermore, in the case where the vehicle passenger is an infant or child, when the vehicle detects that the vehicle passenger is an infant or child because a secondary impact may occur due to an airbag (in case of vehicle collision), the vehicle may control an operation of an airbag so as to prevent the airbag from deploying or to minimize damages to infants or children who are the vehicle passenger.

In addition to Method 1 and Method 2 described above, the vehicle (1) may adjust an angle of a display location for various infotainment (tablet PC attached to a back of a front seat to deliver information and entertainment) in consideration of the comfort of a vehicle passenger, or (2) may adjust a massage device having a massage function installed in the rear seat of the vehicle in consideration of the comfort of the vehicle passenger.

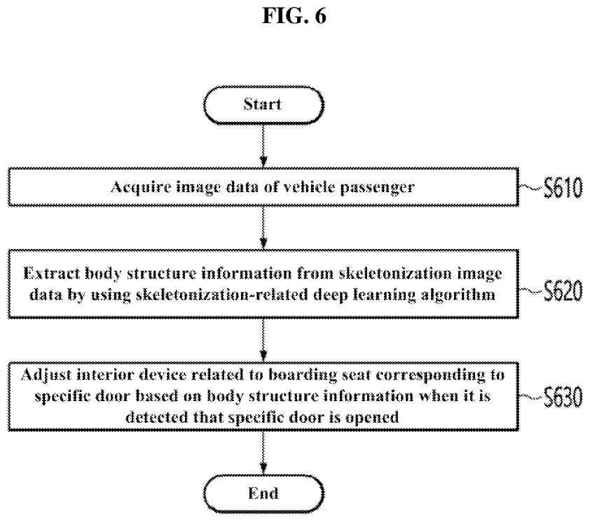

FIG. 6 is a flowchart illustrating an example of a method for adjusting an interior device of a vehicle proposed in this specification.

First of all, a vehicle acquires image data of a vehicle passenger located within a predetermined distance from the vehicle through an object detection device installed outside the vehicle (S610).

The object detection device may include one stereo camera or two cameras.

Alternatively, the object detection device may consist of one ultrasonic sensor and one camera.

The image data may include distance information indicating a distance between the vehicle and the vehicle passenger.

Next, the vehicle extracts body structure information about a body structure of the vehicle passenger from image data by using a skeletonization-related deep learning algorithm (S620).

Here, the body structure information may include at least one of body portion location information about a location of each body portion related to the adjustment of an interior device in the body structure of the vehicle passenger, body portion size information for each size of the body portion, or specific detail information of a body portion with specific details in the body structure of the vehicle passenger.

Here, each body portion related to the adjustment of the interior device may be an eye, an elbow, a knee, a waist, an arm, a leg, an upper body, a neck, and the like.

Here, information about specific details may correspond to whether the vehicle passenger is pregnant, whether the vehicle passenger is disabled, or the like.

Here, the size of each body portion may be calculated based on distance information included in the image data.

Next, when it is detected that a specific door of the vehicle is opened, the vehicle adjusts an interior device related to the boarding seat corresponding to the specific door based on the extracted body structure information (S630).

The interior device may include at least one of a seat corresponding to the specific door, a steering wheel, a rear-view mirror, a side minor, a display device disposed in a rear seat of the vehicle, a massage device, an airbag, or a safety belt.

Here, the airbag or the seatbelt may be adjusted when the vehicle passenger is an infant or child.

In more detail, when the opening of the specific door is detected by the sensing device of the vehicle, the vehicle may allow the interior device to be adjusted based on the extracted body structure information.

Additionally, the vehicle may output a notification signal indicating that acquisition of the image data is ended, in a visual, auditory, olfactory or tactile form. Here, as shown in FIG. 1, the vehicle may further include an output unit to output the notification signal.

That is, the output unit may generate an output related to visual, auditory, or tactile sensation, and may include a display unit, a sound output module, an alarm unit, and a haptic module.

The display unit displays (outputs) information processed by the vehicle. The display unit may include at least one of a liquid crystal display (LCD), a thin film transistor-liquid crystal display (TFT LCD), an organic light emitting diode (OLED), a flexible display, and a 3D display.

A part of these displays may be implemented with a transparent display or a light-transmitting display such that a user sees the outside through the part of these displays. This may be called a transparent display, and a typical example of the transparent display includes a transparent OLED (TOLED). The rear structure of the display unit may also be implemented as a light transmitting structure.

The embodiments described above are those in which elements and features of the inventive concept are combined in a predetermined form. Each component or feature should be considered optional unless explicitly stated otherwise. Each component or feature may be implemented in a form not combined with other components or features. Moreover, it is also possible to configure an embodiment of the inventive concept by combining some components and/or features. The order of operations described in embodiments of the inventive concept may be changed. Some configurations or features of an embodiment may be included in another embodiment, or may be replaced with corresponding components or features of another embodiment. It is obvious that claims that do not have an explicit citation relationship in the accompanying claims may be combined to form an embodiment or may be included as a new claim by amendment after filing.

An embodiment of the inventive concept may be implemented by various means, for example, hardware, firmware, software, or a combination thereof. In the case of implementation by hardware, an embodiment of the inventive concept may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessor, and the like.

In the case of implementation by firmware or software, an embodiment of the inventive concept may be implemented in the form of a module, procedure, or function that performs the functions or operations described above. Software code may be stored in a memory to be run by a processor. The memory may be located inside or outside the processor, and may exchange data with the processor by various means known in the art.

It is obvious to those skilled in the art that the inventive concept may be embodied in other specific forms without departing from the essential characteristics of the inventive concept. Accordingly, the above-described detailed description should not be construed as being limited in all respects and should be considered to be illustrative. The scope of the inventive concept should be determined by reasonable interpretation of the appended claims, and all changes within the equivalent scope of the inventive concept are included in the scope of the inventive concept.

According to an embodiment of the inventive concept, an example in which a method for automatically adjusting an interior device of a vehicle including a driver seat is applied to the vehicle is described, but it is possible to apply the method to various products to which the method is capable of being applied.

According to the present specification, a user convenience may be increased by obtaining image data of a vehicle passenger and automatically adjusting a seat of a passenger seat or interior devices in a vehicle by using body structure information of the vehicle passenger.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A vehicle for adjusting an interior device, the vehicle comprising:
an object detection device installed outside the vehicle and configured to acquire image data of a vehicle passenger located within a predetermined distance from the vehicle, wherein the image data includes distance information indicating a distance between the vehicle and the vehicle passenger;
an artificial intelligence (AI) device configured to extract body structure information about a body structure of the vehicle passenger from the image data by using a skeletonization-related deep learning algorithm, wherein the body structure information includes at least one of body portion location information about a location of each of body portions related to adjustment of the interior device in the body structure of the vehicle passenger, body portion size information for a size of each of the body portions, or specific detail information of a body portion with specific details in the body structure of the vehicle passenger;
a sensing device configured to detect whether a specific door of the vehicle is opened or closed; and
a control device configured to adjust an interior device related to a boarding seat corresponding to the specific door based on the extracted body structure information.

2. The vehicle of claim 1, wherein, when it is detected by the sensing device that the specific door is opened, the control device allows the interior device to be adjusted based on the extracted body structure information.

3. The vehicle of claim 1, wherein the size of each of the body portions is calculated based on the distance information included in the image data.

4. The vehicle of claim 1, wherein the specific detail information corresponds to whether the vehicle passenger is pregnant or whether the vehicle passenger is disabled.

5. The vehicle of claim 1, wherein each of the body portions related to the adjustment of the interior device is an eye, an elbow, a knee, a waist, an arm, a leg, an upper body, or a neck.

6. The vehicle of claim 1, further comprising:
an output unit,
wherein the control device allows the output unit to output a notification signal indicating that acquisition of the image data is ended, in a visual, auditory, olfactory or tactile form.

7. The vehicle of claim 1, wherein the object detection device consists of one stereo camera, two cameras, or one ultrasonic sensor and one camera.

8. The vehicle of claim 1, wherein the interior device includes at least one of a seat of the boarding seat corresponding to the specific door, a steering wheel, a rear-view minor, a side minor, a display device disposed in a rear seat of the vehicle, a massage device, an airbag, or a safety belt.

9. The vehicle of claim 8, wherein the control device adjusts the airbag or the safety belt when the vehicle passenger is an infant or child.

10. A method for adjusting an interior device of a vehicle, the method comprising:
acquiring image data of a vehicle passenger located within a predetermined distance from the vehicle through an object detection device installed outside the vehicle, wherein the image data includes distance information indicating a distance between the vehicle and the vehicle passenger;
extracting body structure information about a body structure of the vehicle passenger from the image data by using a skeletonization-related deep learning algorithm, wherein the body structure information includes at least one of body portion location information about a location of each of body portions related to adjustment of the interior device in the body structure of the vehicle passenger, body portion size information for a size of each of the body portions, or specific detail information of a body portion with specific details in the body structure of the vehicle passenger; and
when it is detected that a specific door of the vehicle is opened, adjusting an interior device related to a boarding seat corresponding to the specific door based on the extracted body structure information.
